(19) United States
(12) Patent Application Publication
(10) Pub. No.: US 2009/0164231 A1
(43) Pub. Date: Jun. 25, 2009

(54) Fee management system

(75) Inventors: Ryan Robert Fox, Minneapolis, MN (US); Jeremy Martin Peyer, Richfield, MN (US); Joshua James Vandebogert, St. Louis Park, MN (US)

Correspondence Address: BERGGREN LAW OFFICES, LLC, 7090 43RD STREET NORTH, OAKDALE, MN, 55128, US

(73) Assignee: Auncor, Inc

(21) Appl. No.: 12/070,137

(22) Filed: Feb. 15, 2008

Related U.S. Application Data
(60) Provisional application No. 60/936,203, filed on Jun. 19, 2007.

(51) Int. Cl. G06Q 10/00

(52) U.S. Cl. 705/1

(57) ABSTRACT

A system is taught for out-sourced management of educational institution fee arrangements that reduce the contacts with a responsible party of a student during the finalization of fee payment arrangements to a single contact. Specifically, the invention includes a system that includes a means for providing a single personalized communication with a responsible party. The single communication includes a third party fee management agreement and at least one of a group consisting of a fee notification and an educational institution payment agreement.

This reduces time and anxiety on part of a responsible party during the fee arrangement part of an enrollment process in an educational institution using out-sourced fee management services.

### CROSS REFERENCE TO RELATED APPLICATIONS

This application claims the benefit of PPA Appl No. 60/936,203 filed Jun. 19, 2007 by the Ryan Robert Fox, Jeremy Martin Peyer, and Joshua James Vandebogert.

### FIELD OF THE INVENTION

This invention relates to third party management of educational institution tuition or fee payments by responsible parties.

### BACKGROUND OF THE INVENTION

There is a need to simplify the process that responsible parties use to finalize fee payment plans of educational institutions that are managed by third parties. Currently multiple contacts with responsible parties are necessary to establish these arrangement.

Fees sought by educational institutes from persons responsible for costs associated with the attendance of a student come in many forms and often are reduced by grants, by financial aid awards, and by other discounts. Many educational institutions are either too small to efficiently manage fee payments by responsible parties or are not interested in personally managing the fee payments due institutional priorities. In an effort to reduce costs, such institutions increasingly are using third parties that specialize in these activities to handle such arrangements. However, this practice has resulted in a responsible party receiving multiple mailings to finalize the arrangements. One mailing from the institution notifies the party of the tuition award and seeks a contract of payment obligation between the institution and the party. Then a second mailing that details selected payment arrangements is sent from the institution that seeks a contract between the third party fee management entity and the responsible party. The potential for confusion and missed deadlines increases where a responsible party has more than one individual applying to more than one educational institution.

Efforts by others have not solved this problem. Some have focused on computer programs that allow a student to track various sources of funding. Others have taught online systems for private educational institutions to determine fee payments.

There is still a need for a method and system that minimizes the contacts made to responsible parties during the finalization of fee payment arrangements

### SUMMARY OF THE INVENTION

We have invented a system, method and apparatus for out-sourced management of educational institution fee arrangements that reduce the contacts with a responsible party of a student during the finalization of fee payment arrangements to a single contact. Specifically, we have invented a system that includes a means for providing a single personalized communication with a responsible party. The single communication includes a third party fee management agreement and at least one of a group consisting of a fee notification and an educational institution payment agreement.

We have also invented a method that includes providing a single personalized communication with a responsible party. The single communication comprises a third party fee management agreement and at least one of a group consisting of a fee notification and an educational institution payment agreement.

Further, we have invented an apparatus that includes a computing device configured to be able to receive and manipulate educational institution fee data and data about prospective student to provide a single personalized communication with a responsible party. The communication comprises a third party fee management agreement and at least one of a group that consisting of a fee notification and an educational institution payment agreement.

As used herein:

“Educational institution” means an institution that seeks payment of “fees” from a “responsible party” to itself through a “third party fee management entity”.

“Educational institution payment agreement” means an agreement between a “responsible party” and an educational institution for payment of fees described in “fee notification” in exchange for attendance by a student.

“Fees” means the net fee that is calculated from at least one of a group of factors comprising a base fee, a base tuition, costs for activities, costs for books, costs of usage of facilities and equipment, grants, multiple enrollment discounts and financial aid awards.

“Fee notification” means a communication to one of the responsible party, the student, or an address provided on an application regarding the attendance at the educational institution by the student that includes the net fee sought by the institution for attendance by the student; the “net fee” comprising a base fee and applicable discounts.

“Responsible party” means person(s) responsible for payment of fees and (1) may be responsible for multiple students if responsible party is parent and several minor children are accepted to school, or (2) may be multiple people if two or more people are responsible, and may be student if student is responsible for tuition.

“Single personalized communication” means the initial transmission of at least a third party fee management agreement and at least one of a group consisting of a fee notification and an educational institution payment agreement to one of the responsible party, the student, or an address provided on an application regarding the attendance at the educational institution by the student

“Third party fee management agreement” means an agreement between “responsible party” and a “third party fee management entity” that includes a name and contact information for the responsible party, a selected payment plan and payment method, and, optionally, a third party processing fee.

“Third party fee management entity” means an entity that manages the payment of a fee due an educational institution by a “responsible party” according to agreed payment times and method.

Our invention benefits the responsible party making arrangements for fee payments to a third party fee payment management entity by reducing the number of mailings needed to finalize plans. The acceptance of a student to an educational institution and the payment arrangements for fees can be a stressful time for an increasing number of responsible parties. This is aggravated by occasions when more than one student is involved or when more that one educational institution is being approached. Our invention reduces the number of times a responsible party is contacted to finalize fee payment arrangements. This reduces stress on both the responsible parties and the students, and minimizes possible confusion from multiple mailings.

### BRIEF DESCRIPTION OF THE DRAWINGS

One or more features or preferred forms of the invention are described in the accompanying drawings. The drawings are briefly described below.

FIG. 1 is a flow diagram showing an embodiment of the method of our invention.

FIG. 2 is a flow diagram showing a typical method in current use by educational institutions that use fee management entities.

### DETAILED DESCRIPTION OF SOME EMBODIMENTS OF THE INVENTION

For the purposes of this document, an educational institution is one that requires a fee for a student to addend some aspect of what is offered by the institution. It may be private or public and may be referred to interchangeably in this document as educational institution or institution.

Educational institutions are under increasing pressures to manage costs and refocus energies on core activities that further education. As a result, more institutions that charge students some form of fees are turning to a third party fee management entity to manage the collection of the fees.

Many private educational institutions have used third party fee management entities for a while. This is particularly true when the institutions are small or are unmotivated to spend the time necessary for the task that can be quite complex.

In recent years, public educational institutions are beginning to consider using third party fee management entities for various reasons as the institutions are passing more and more charges on to students for such things as participation in sports, band, choir, field trips and a growing number of other extra curricular activities.

Fees can be quite complex. The calculations can be involved and highly individualistic. Then the notifications and attainment of necessary contracts can be time-consuming. In addition, the plans may be modified during the life of the contracts as fee-based services are either added or deleted, where deletion is available. Finally, the collection of fees, often on a periodic program and with a variety of methods, may be tedious and distracting from the mission of an education al institution.

Typically, fees mean net fees and include gross or base fees less various discounts. Base fees are costs to students for attending an institution and include, for example, such items as a base tuition (for private institutions), costs for activities, costs for books and costs of usage of facilities and equipment to arrive at a gross fee. This fee is then reduced by a variety of discounts including, for example, multiple student discounts, grants, scholarships, and other financial aid awards to arrive at a net fee or fee.

Once fees are determined, the institution sends several communications to the student or to a responsible party, if known, to solidify payment obligations. If the communications go to a student, they are generally passed on to the responsible party. Contracts are then with the responsible party.

The responsible party is one or more people who assume responsibility for payment of the fees. The responsible party may be responsible for multiple students in cases, for example, where the responsible party is a parent and several minor children are accepted to a particular educational institution that requires fee payment. Also, the responsible party may be multiple people if two or more people are responsible. In addition, the responsible party may be the student where the student is personally responsible for fees and has the financial resources to pay the fees.

A third party fee management entity is an entity that manages the payment of a fee due an educational institution by a responsible party according to agreed payment times and method. Generally a responsible party contracts separately with a third party fee management entity for a payment plan selected by the party. Payment plans may be those that involve one payment or payments over a specified period of time. Payment plans typically include method of payment, such as, by check, money order, credit card of other. Also, a processing fee is often added to the fees by the management entity.

For the purposes of this document, an educational institution is one that requires a fee for attendance by a student. This payment of the fee is to come from a responsible party through a third party fee management entity. The educational institution may be private or public and may be referred to interchangeably in this document as educational institution or institution.

Various communications presently occur to finalize fee arrangements. One is a fee notification. The fee notification is typically sent to the address listed on an application for the student to attend an institution. This notice informs what the fee is and offers various payment plans, sometimes for additional fees.

A second communication is an educational institution payment agreement. This is an agreement between the responsible party and an educational institution for payment of fees described in the fee notification in exchange for attendance by a student. This agreement may be modified or supplemented if additional fee-based activities are desired by the student during the term of the original agreement.

A third communication is a third party fee management agreement. This is an agreement between the responsible party and a third party fee management entity. It typically includes a name and contact information for the responsible party, a selected payment plan and payment method, and, optionally, a third party processing fee.

Presently, the third communication is sent separately to a responsible party from the other two. This is increases the anxiety on the part of a responsible party and may cause some confusion where multiple institutions and multiple students are involved.

In addition to providing benefits to the responsibility party, others benefit as well from our invention. The institution accomplishes necessary communications more efficiently and less expensively. Also, the student has a more concise transmission where the student is interested in financial arrangements. As family budgets are becoming more strained, students are often forced to become more conscious of costs despite their interests.

One embodiment of our invention is a system. The system allows us to transmit in a single communication at least two communications to the responsible party, the student, or an address provided on an application regarding the attendance at the educational institution by the student. The single communication includes (1) a third party fee management agreement and (2) at least one from a group consisting of a fee notification and an educational institution payment agreement.

In this document a single personalized communication means the initial transmission of at least a third party fee management agreement and at least one of a group consisting of a fee notification and an educational institution payment agreement to one of the responsible party, the student, or an address provided on an application regarding the attendance at the educational institution by the student. In some embodiments of our invention, a single communication includes all three communications transmitted to a responsible party. Current industry practice is to use a communication process that involves several communications to convey the information to convey information obligating the responsible party to the institution and to the third party fee management entity.

Currently the communication process typically involves a system that includes multiple distinct steps, communications, and databases. One step is that a third party fee management entity provides a blank third party fee management agreement form to an educational institution using the services of the fee management entity. Another step is the educational institution reviews such items as enrollment data, tuition, fees, discounts and aid awards for each student to create a fee notification, also called an award notification. A third step occurs when the educational institution sends to a responsible party, or caretaker of record, of the student's payment obligation the fee notification listing the net payment that is due for the services provides by the educational institution. This first communication to a responsible party is often accompanied with an educational institution payment agreement proposal. The proposal is meant to contractually obligate the educational institution and the responsible party for payment in exchange for services such as, for example, tuition payment for specified attendance at the institution when signed by the responsible party. This agreement proposal often contains various payment options such as, for example, payment of the entire obligation at one time or payment in installments over various periods of time and numbers of payments.

After the first communication to the responsible party, other steps occur that end in another communication. In a first step, the responsible party completes the agreement form by signing the contract, selecting the payment plan option desired, and returning the agreement proposal to the institution. In a second step, the institution uses this proposal to finalize the payment plan of each student, including preparing a personalized third party fee management agreement form from a blank form presently provided by a third party fee management entity. Thirdly, the educational institution sends a second communication to the responsible party containing the personalized third party fee management agreement.

After the second communication to the responsible party, still other steps usually occur before arrangements are finalized. First the responsible party completers the fee management agreement by selecting payment option plan including frequency and method of payment, signing the agreement form and sending it back to the educational institution. Usually the fee management agreement includes a fee paid to the third party entity for fee management services. Secondly, the institution retains a copy of the signed third party fee management agreement and sends a copy to the third party management entity to begin the process of managing fee payments by the third party entity.

Our invention is unique to institutions and fee management entities. To accomplish the present practice, at least two databases from two different entities are needed to generate the multiple personalized communications to a responsible party that ends in fee management by a third party entity. The educational institution has a database that is capable of generating necessary notifications and agreement forms after a series of several communications with a responsible party. Then a database of the third party fee management entity is used to create a process of managing fee payments from that party by the third party entity. In addition, there is minimal communication between an educational institution and a third party fee management entity until the institution supply the entity with the information necessary to create by the entity a personalized process of managing fee payments from a responsible party. Thus single communications are currently not known.

As stated above, our system reduces the communications made to a responsible party to create a personalized fee maintenance process to a single communication. The system includes a database, means for creating personalized notification and agreement forms, and means for transmitting a single communication regarding fees. The first element, the database, contains sufficient data on the fee arrangements by the educational institution on at least one student and data on the student to allow the generation of a third party fee management agreement and at least one of the group that consists of a fee notification and an educational institution payment agreement. This may be presently available to some third party entities but not recognized by them or their institution clients as being useful to generate single communications.

The second element, a means for creation of personalized notices and agreements through interactive communication with data base, is able to generate several personalized forms. These forms include at least a third party fee management agreement and at least one of the group that consists of a fee notification and an educational institution payment agreement. The means for creation is able to consider frequency and method of payment, processing fees, and net fees due educational institution by responsible party. One means is an interactive program able to selectively abstract relevant data from the data base and create personalized communications that are sent to a responsible party including the three discussed above. This can be done by known programming techniques once the database is available and the need to create a single communication is recognized.

The third element is a means for transmitting a single communication that is able to transmit the single communication to an address provided by a student or responsible party. This means for transmitting is in communication with the means of creation to obtain the relevant personalized communications to be transmitted. This communication is generally electronic in nature. The means for transmitting includes any method for transmitting the forms to the recipient, including mail, email, telegram, or facsimile. One embodiment uses communication by material conveyance such as, for example, by various mailing services. Another embodiment used communication by internet access with secured procedures. The common feature is that the communication includes at least a third party fee management agreement and at least one of the group consisting of a fee notification and an educational institution payment agreement.

Another embodiment of our invention is a method. The method is one of transmitting in a single communication at least a third party fee management agreement and at least one of a group consisting of a fee notification and an educational institution payment agreement to one of the responsible party, the student, or an address provided on an application regarding the attendance at the educational institution by the student.

The method includes three steps. The first step is to provide a necessary database to create the personalized communications. The database contains sufficient data on the fee arrangements of the educational institution for at least one student, data on the student, and date on fee management procedures to be able to generate a third party fee management agreement and at least one of the group consisting of a fee notification and an educational institution payment agreement. This often requires institutions to provide information that they have in the past kept internally.

The second step is to create personalized forms. These forms include a third party fee management agreement and at least one of the group that includes a fee notification and an educational institution payment agreement. Details describing how this is done are discussed above.

The third step is to transmit a single communication to contractually obligate a responsible party to both an institution and a fee management entity. The communication is conveyed to an address provided by a student or responsible party and includes a third party fee management agreement and at least one of the group consisting of a fee notification and an educational institution payment agreement. Communication may be by either electronic or material conveyance as previously described.

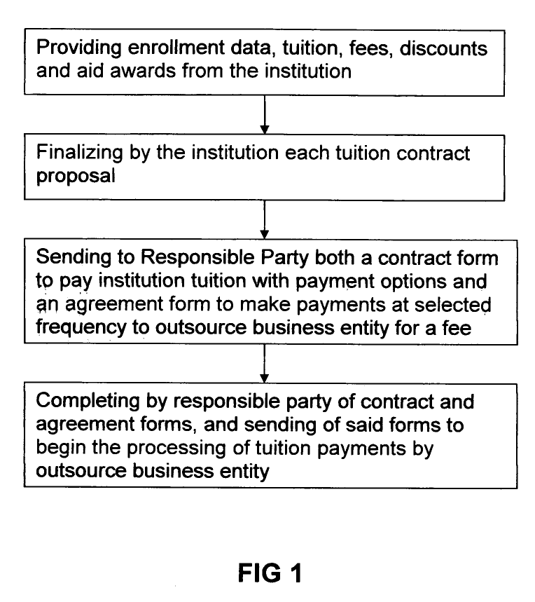

An embodiment of the method includes the four steps shown in FIG. 1. The first step includes providing enrollment data, tuition, fees, discounts and aid awards from the school. The enrollment date includes at least a student name, but may also include grade, student identification number and/or other contact or identification information. Tuition is often calculated by credit hour, grade, or other method that is useful to the institution. In the second step, the institution finalizes the tuition contract of each student.

The third and fourth steps involve a single personalized communication. In the third step, the responsible party is both a contract form and an agreement. The contract is to obligate the responsible party to pay the institution the school tuition and typically includes various payment options offered by the institution. The agreement form is to obligate the responsible party to make payments at a selected frequency to the third party fee management entity. This latter often includes a fee to the entity for its services. However, optionally, the fee may be paid by the institution. In the fourth step, the contract and agreement are completes by the responsible party and conveyed to either the entity or the institution, or both. If the signed forms are conveyed to either the entity or the institution, then the receiving organization communicates the necessary evidence of obligation to the other.

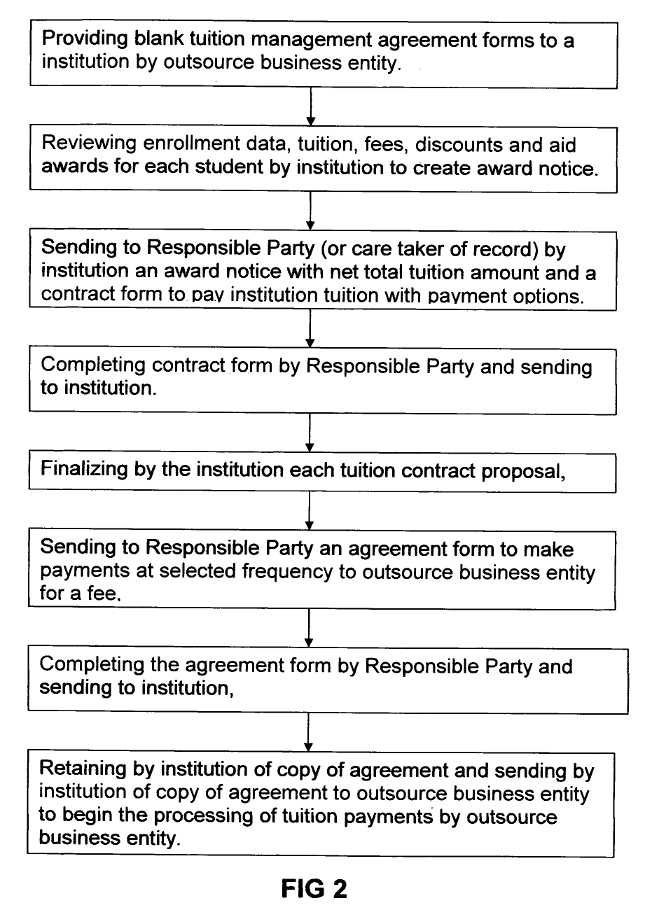

In contrast, the present method of transmitting this information is more convoluted and typically includes the eight steps shown in FIG. 2. First, blank tuition management agreement forms are provides to the educational institution by the third party fee management entity. Second, to create an award notice, the institution reviews enrollment data, tuition, fees, discounts and aid awards for each student. Third, the institution sends the responsible party (or caretaker of record) a first communication that contains an award notice with net total tuition amount and a contract form to pay school tuition with payment options. Fourth, the responsible party completes the contract and sends it to the institution. Fifth, the institution finalizes each student contract and enters student information into the blank fee management form. Sixth, the institution sends to the responsible party a second communication that contains a personalized agreement form to make payments at selected frequency to a third party fee management entity for a fee. Seventh, the responsible party completes the agreement form and sends it to the institution. Finally, the institution retains a copy of the agreement and sends a copy to the fee management entity to enter in its system to be able to process tuition payments.

Still another embodiment of our invention is an apparatus for out-sourced management of educational institution fee arrangements. This apparatus includes a computing device properly configures to result in a single fee-related communication to a responsible party. Specifically, the computing device is configured to be able to receive and manipulate educational institution fee data and data about prospective student to provide a single personalized communication with a responsible party. The communication comprises a third party fee management agreement and at least one of a group consisting of a fee notification and an educational institution payment agreement.

The configurations of the computing device include the following three elements, a database, a means for creating documents and a means for transmitting a single communication relating to fees. The first element, a database, contains sufficient data on the fee arrangements of the educational institution for at least one student and data on the student to be able to generate a third party fee management agreement and at least one of the group consisting of a fee notification and an educational institution payment agreement.

The second element, a means for creating documents, is a means for creation of personalized forms that comprise at least a third party fee management agreement and at least one of the group consisting of a fee notification and an educational institution payment agreement. This means is in interactive communication with database to be able to create personalized fee-related documents suitable for mailing to responsible parties of persons desiring participation in fee-based activities of educational institutions.

The third element, a means for transferring the single communication, is a means for transmitting fee-related documents in a single communication to an address provided by a student or responsible party. The means for transferring is in interactive communication with the database and the means for creating personalized forms to be able convey a single communication comprising a third party fee management agreement and at least one of the group consisting of a fee notification and an educational institution payment agreement. The means for transferring are well-known and may be designed for electronic or material communication. Electronic means include, for example, internet or other electronic communication apparatus. Material means include, for example, printers that produce paper documents that are subsequently conveyed by U.S. Mail, facsimile, or other delivery channels.

The database and the means for transmitting are presently known in parts for other applications. The means for creating personalized communications was created by us to interact with the database and means for transmitting to accomplish the goal of a single communication as defined above. Surprisingly, this was not done before. Apparently institutions have not had the means to create third party fee payment agreements because that is why they hire third party fee management entities. Third party fee management entities have not had the ability to create fee notifications or institution payment agreements because of lack of access to the relevant information from the institution or lack of appreciation of the benefits to the responsible party or motivation to create the benefit.

Other embodiments will be apparent to those skilled in the art. This document is meant to include all embodiments that encompass the spirit and purpose of the invention.

We claim:

1. A system for out-sourced management of educational institution fee arrangements, comprising, a means for providing a single personalized communication with a responsible party, said communication comprising a third party fee management agreement and at least one of a group consisting of a fee notification and an educational institution payment agreement.

2. The system of claim 1 wherein the third party fee management agreement comprises a name and contact information for the responsible party, a selected payment plan and payment method, and a third party processing fee.

3. The system of claim 1 wherein the fee notification comprises the net amount sought by the institution for attendance by the student, the net amount comprising a base fee and applicable discounts.

4. The system of claim 3 wherein the net fee is calculated from at least one of a group of factors consisting of a base fee, a base tuition, costs for activities, costs for books, costs of usage of facilities and equipment, grants, multiple enrollment discounts and financial aid awards.

5. The system of claim 1 wherein the educational institution payment agreement comprises an agreement to attend the institution and pay fees described in fee notification.

6. The system of claim 5 wherein the agreements may be amended by parties during a term of the agreement.

7. The system of claim 1 wherein the educational institution is an institution that seeks payment of fees from a responsible party to a third party.

8. The system of claim 1 wherein the single transmission is from the educational institution or the third party.

9. The system of claim I wherein the single communication comprises both a tuition award communication and a tuition payment agreement with an educational institution.

10. The system of claim 1 wherein the means for providing, comprises,
a database containing sufficient data on the fee arrangements by the educational institution on at least one student and data on the student to allow the generation of a third party fee management agreement and at least one of the group consisting of a fee notification and an educational institution payment agreement,
means for creation of personalized notices and agreements through interactive communication with data base, said forms comprising at least a third party fee management agreement and at least one of the group consisting of a fee notification and an educational institution payment agreement, and
means for transmitting a single communication to an address provided by a student or responsible party, said means of transmitting is in communication with said means of creation and said communication comprising at least one of the group consisting of a fee notification and an educational institution payment agreement, a third party fee management agreement and at least one of the group consisting of a fee notification and an educational institution payment agreement.

11. The system of claim 10 wherein the database received final instructions from educational institution regarding student fee proposal before personalized notices and agreements are created and a single transmission is conveyed.

12. The system of claim 10 wherein the means of transmission is a material mailing to the responsible party, the student or an address provided on an application regarding the attendance at the educational institution by the student.

13. The system of claim 10 wherein the means of transmission is an internet site accessible by use of a secure procedure conveyed to the responsible party, the student or an address provided on an application regarding the attendance at the educational institution by the student.

14. A method for out-sourced management of educational institution fee arrangements, comprising, providing a single personalized communication with a responsible party, said communication comprising a third party fee management agreement and at least one of a group consisting of a fee notification and an educational institution payment agreement.

15. The method of claim 14 wherein providing a single communication, comprises,
providing a database containing sufficient data on the fee arrangements of the educational institution for at least one student and data on the student to be able to generate a third party fee management agreement and at least one of the group consisting of a fee notification and an educational institution payment agreement,
creating personalized forms comprising a third party fee management agreement and at least one of the group consisting of a fee notification and an educational institution payment agreement, and
transmitting a single communication to an address provided by a student or responsible party, said communication comprising a third party fee management agreement and at least one of the group consisting of a fee notification and an educational institution payment agreement.

16. The method of claim 14 wherein the single communication comprises both a fee notification and an educational institution payment agreement.

17. The method of claim 15 wherein transmitting is through a material mailing to the responsible party, the student or an address provided on an application regarding the attendance at the educational institution by the student.

18. The method of claim 15 wherein transmitting is through communication with an internet site in communication with the data base and accessible by use of a secure procedure conveyed to the responsible party, the student or an address provided on an application regarding the attendance at the educational institution by the student.

19. An apparatus for out-sourced management of educational institution fee arrangements, comprising, a computing device configured to be able to receive and manipulate educational institution fee data and data about prospective student to provide a single personalized communication with a responsible party, said communication comprising a third party fee management agreement and at least one of a group consisting of a fee notification and an educational institution payment agreement.

20. The apparatus of claim 19 wherein the configurations of the computing device, comprise,
a database containing sufficient data on the fee arrangements of the educational institution for at least one student and data on the student to be able to generate a third party fee management agreement and at least one of the group consisting of a fee notification and an educational institution payment agreement,
means for creation of personalized forms that comprise at least a third party fee management agreement and at least one of the group consisting of a fee notification and an educational institution payment agreement, said means is in interactive communication with database, and
means for transmitting a single communication to an address provided by a student or responsible party, said means of transmitting is in interactive communication with said database and said means for creating personalized forms to be able convey a single communication comprising a third party fee management agreement and at least one of the group consisting of a fee notification and an educational institution payment agreement.
